(19) United States
(12) Patent Application Publication
(10) Pub. No.: US 2006/0261267 A1
(43) Pub. Date: Nov. 23, 2006

(54) Composite MALDI matrix material and methods of using it and kits thereof in MALDI

(75) Inventors: Siu Kwan Newman Sze, Singapore City (SG); Lin Hua, Singapore City (SG)

Correspondence Address: FOLEY & LARDNER LLP, P.O. BOX 80278, SAN DIEGO, CA, 92138-0278, US

(73) Assignee: Agency for Science, Technology and Research

(21) Appl. No.: 11/133,845

(22) Filed: May 20, 2005

(51) Int. Cl. H01J 49/16

(52) U.S. Cl. 250/288; 250/282

(57) ABSTRACT

The present invention relates to a composite matrix material for Matrix-assisted Laser Desorption/Ionisation (MALDI), a process for preparing the same, and a method of its use in MALDI. The invention also relates to a kit for carrying out MALDI. The matrix material comprises at least one MALDI matrix forming compound and a polymer. The polymer serves as supporting material for the at least one MALDI matrix forming compound to which it is covalently linked.

### FIELD OF THE INVENTION

The present invention relates to a composite matrix material for Matrix-assisted Laser Desorption/Ionisation (MALDI), a process for preparing the same, and methods of its use in MALDI. The invention also relates to a kit for carrying out MALDI. The matrix material comprises at least one MALDI matrix forming compound and a polymer. The polymer serves as supporting material for the at least one MALDI matrix forming compound to which it is covalently linked.

### BACKGROUND OF THE INVENTION

Matrix-Assisted Laser Desorption/ionisation (MALDI) mass spectro-metry allows for the identification and characterization of complex mixtures, such as biological material comprising for instance protein and peptide mixtures. MALDI mass spectrometry is used in a variety of applications. A field of extensive use are life sciences, where it is for instance applied to protein identification and proteome analysis based on the principle of peptide mass finger printing and peptide sequencing (Warscheid, B, et al., Anal. Chem. 75, (2003), 5608-5617), DNA/RNA sequencing (Spottke, B, et al., Nucleic Acids Res. 32 (2004), 12, e97), typing of single nucleotide polymorphisms (Sauer, S, et al., Nucleic Acids Res. 30, (2002) 5, p.e22), the screening for (intact) microorganisms (see e.g. Fenselau, C, Demirev, P A, Mass Spectrom. Rev, 20, (2001), 157-171), molecular imaging of thin slices of tissues and cells (see e.g. Chaurand, P, et al., Curr. Opin. Chem. Biol., 6, (2002), 676-681), or the profiling of ion patterns as markers in the diagnosis of disease (e.g. Petricoin, E F, et al., Lancet 359, (2002), 572-77). Other applications include for example the determination of the molecular mass distribution of synthetic polymers (Wetzel, S. J., et al., Int. J Mass Spectrometry, 238, (2004), 3, 215-225) or the analysis of changes induced by the cleaning of paintings (Castillejo, M, et al., Anal. Chem. 74, (2002), 4662-4671).

MALDI mass spectrometry generally involves a pre-treatment of the sample prior to the analysis. This pre-treatment consists of finely dispersing the analyte in a large excess of an organic matrix material. Typically a volume of about 1 μl of the obtained mixture is then pipetted onto a metal substrate plate and allowed to dry. The analysis itself is started by irradiating the obtained solid by a pulsed laser (see FIG. 1A). As the matrix absorbs the laser light, the matrix vaporizes and carries with it molecules of the sample mixture, whereupon these become ionized. The generated ions can subsequently be detected by a mass analyser, which may be based on the time-of-flight (TOF), quadrupole, ion trap or Fourier transform ion cyclotron resonance (FTICR) methods or by a combination thereof.

A typically technique to detect the generated ions is time-of-flight (TOF) analysis, where the flight time of ions down a field-free flight tube is used to generate a mass spectrum. This technique is based on the fact that the respective time-of-flight of ions is related to their mass to charge (m/z) ratio. The MALDI ionization can be performed under vacuum or atmospheric pressure (Link, A., et al., Nat. Biotechnol. 17, (1999), 676-682), whereas TOF analysis occurs under vacuum. An example of an alternative mass analyser for analysis is Fourier transform mass spectrometry (FTMS) (e.g. Srzić, D, et al., Croatica Chemica Acta 73 (2000), 69-80). The MALDI ionization can similarly be performed under vacuum or atmospheric pressure (Kellersberger, K A, et al., Anal. Chem., 76, (2004), 3930-3934). Ions generated at atmospheric pressure appear to undergo to a lesser extent of metastable decay, thus compensating for the lower overall detection sensitivity compared to analysis under vacuum.

MALDI can also be applied to tandem mass spectrometry. In case of the TOF-technique, the TOF analyser can be associated to a quadrupole mass filter (QqTOF or QTof, see e.g. McLean, J. A., et al., Anal. Chem. 75, (2003), 648-654), to another TOF analyser (TOF-TOF, see e.g. Medzihradszky, K F, et al., Anal. Chem. 72 (2000), 552-558) or to an ion trap analyser (QIT/TOF, e.g. Laiko, V V, et al., Anal. Chem. 72, (2000), 5239-5243).

The matrix material consists of small organic compound molecules, which have an absorbance at the wavelength of the laser used. Typical examples used for the analysis of biomolecules are cinnamic acid or dihydroxybenzoic acid. It is generally assumed that the matrix serves three functions (Kellner, R, et al., Microcharacterization of proteins, 2^{nd} edition, Wiley-VCH, chapter III.4.2). Firstly, it absorbs energy from the laser light used. The resulting vaporization desorbs analyte molecules together with matrix molecules. Secondly, the use of an excess of matrix molecules reduced any intermolecular forces between biomolecules analysed. The matrix thus serves in isolating biomolecules from each other. Thirdly, the matrix is thought to play an active role in the ionization of the analyte molecules by e.g. proton transfer.

One disadvantage of the MALDI method is the generation of background signals, which becomes overwhelming in the low-molecular mass range. This chemical noise results in the suppression of signals originating from the sample. As a consequence, signals below about 700 Da are often discarded as they originate predominantly from the matrix ions themselves. The detection, identification and quantification of biomolecules in this low m/z region thus becomes difficult, if not impossible. As a consequence, in peptide mass fingerprinting as an example of a biological MALDI TOF application, the absence of low m/z peptide signals limits the usability of the method to only relatively large proteins. Interferences can also occur above this low m/z region. Ions of matrix molecules or fragments thereof are able to form adducts with analyte ions, resulting in artefacts and additional signals.

Another disadvantage of the MALDI method is the requirement of a homogenous cocrystallisation of matrix and analyte. Inhomogenous cocrystallisation can easily lead to the occurrence of hot spots on the sample probe. An attempt to overcome this problem lead to the development of liquid matrixes with graphite particulates (Dale, J M, et al., Anal. Chem. 68, (1996), 3321-3329). This method is however not able to avoid the occurrence of background signals originating from the matrix.

Yet another disadvantage of the MALDI method is an inherent limitation in terms of detection sensitivity. This limitation arises from the fact that particularly protein solutions have a limited analyte concentration. Above a certain protein concentration, efforts of further increase inevitably lead to protein precipitation. Furthermore, during sample preparation the analyte solution tends to spread over a large area on the solid target plate, resulting in low concentration per unit area with the result of a relatively low signal intensity. The above mentioned occurance of adducts between ions of matrix molecules and analyte ions also leads to a reduction of the intensity of analyte signals. Yet there is a demand for high detection sensitivity, particularly in protein identification. In case that the analyte solution consists of a protein and peptide mixture, less abundant analytes of interest may thus be too weak to be detected at all.

There is also a demand for automated MALDI analysis for screening purposes, which requires automated sample application. The requirement to generate a homogenous mixture of analyte and matrix material for MALDI bears the risks of errors in this respect. Additionally, although automated MALDI sample preparation is generally capable of performing the required mixing, the preparation process is complicated and prolonged by this step. It would thus be advantageous to rely on a mass spectrometry screening technique that does not depend on such a mixing step.

Efforts to overcome the generation of background signals have lead to the use of porous silicon instead of low molecular weight organic matrix molecules (Wei, J, et al., Nature 399 (1999), 243-246), a method termed desorption/ionization on silicon or ‘DIOS’. Although it is currently not understood how silicon is able to perform the above cited three functions of the MALDI matrix, the porous structure of the surface is known to be essential (Wei, J, et al., supra). A recent application of this method (Thomas, J J, et al., Proc Natl Acad Sci U.S.A. 98, (2001), 9, 4932-4937) is the use of a porous silicon target plate, a so-called ‘DIOS chip’. For a number of cases such chips however have to be specially prepared prior to sample preparation, e.g. by immersion in hydrogen peroxide for the analysis of oligosaccharides. Although DIOS results in a significant reduction in background noise, it does not lead to its complete absence (Shen, Z, et al., Anal Chem. 73 (2001), 612-619; Kruse, R A, et al., Anal Chem. 73 (2001), 3639-3645). Signals of background ions are detected particularly in the 200-300 and 400-600 m/z ranges, and can be of an intensity suppressing analyte signals (ibid.). Some of these remaining background signals have been speculated to originate from hydrocarbons, which are known to bind to porous silicon (Shen et al., supra).

A disadvantage of DIOS is the variability of signal intensities. One source of such variability are inevitable variations in the preparation of the chip prior to sample application tend to lead to corresponding variations in signal intensities. Another source of variations in signal intensities is the preparation of the porous surface itself by means of galvanostatic etching, since etching parameters such as silicon crystal orientation, light intensity, dopant type, dopant level, current density, etching solution and etching time are known factors to affect porous silicon morphology (Shen, Z, et al., supra). Yet another source of variability is the fact that porous silicon surfaces become oxidized upon storage in air (ibid).

As an alternative to DIOS, carbon nanotubes have been used as substrates for analyte trapping and energy transfer (Xu, S, et al., Anal. Chem. 75, (2003), 6191-6195). However, their tedious preparation (Li, Y F, et al., Chem. Phys. Lett. 366, (2002), 544-550) forms an obstacle to their routine usage in MALDI mass spectrometry.

As yet another alternative, disclosed in WO2005/022583, a thin layer coating of a mixture of a MALDI matrix material and an intercalating agent such as a polymer has been used.

Accordingly it is an object of the present invention to provide an alternative method for carrying out MALDI, which overcomes the above noted disadvantages.

### SUMMARY OF THE INVENTION

The present invention provides a composite matrix material for Matrix-assisted Laser Desorption/Ionisation (MALDI) and a process for preparing the same. The invention also provides a kit for carrying out MALDI. The invention furthermore provides methods of using the composite matrix material or a respective kit in MALDI.

Thus in one aspect the invention provides a composite matrix material for Matrix-assisted Laser Desorption/Ionisation (MALDI), wherein the material comprises at least one MALDI matrix forming compound and a polymer. The polymer serves as supporting material for the at least one MALDI matrix forming compound to which it is covalently linked.

In another aspect the inventions provides a process for preparing a composite matrix material for Matrix-assisted Laser Desorption/Ionisation (MALDI), comprising reacting at least one MALDI matrix forming compound, and at least one modifiable polymer. After the reaction the generated polymer serves as supporting material for the generated at least one MALDI matrix forming compound in the composite matrix material. In the course of the reaction process the at least one MALDI matrix forming compound gets covalently linked to the modifiable polymer.

In a further aspect the inventions provides a method for providing analyte ions for Matrix-assisted Laser Desorption/Ionisation (MALDI) mass spectrometry. The method includes:
(a) providing a composite matrix material comprising at least one MALDI matrix forming compound and a polymer which serves as supporting material for the at least one MALDI matrix forming compound, wherein the MALDI matrix forming compound is covalently linked to the polymer,
(b) contacting said composite matrix material for MALDI with an amount of an analyte, and
(c) irradiating the composite matrix material to desorb and ionize said analyte.
   The generated analyte ions are suitable for analysis of their mass to charge ratio (m/z) in mass spectrometry.

In yet another aspect the inventions provides a substrate for MALDI. The substrate comprises a solid support, which has deposited thereon a composite matrix material for Matrix-assisted Laser Desorption/Ionisation (MALDI). The composite matrix comprises at least one MALDI matrix forming compound, and a polymer. The polymer serves as supporting material for the at least one MALDI matrix forming compound, wherein the MALDI matrix forming compound to which it is covalently linked.

In another aspect the invention provides a kit for MALDI comprising one container that includes at least one MALDI matrix forming compound, and a second container that includes at least one modifiable polymer. The modifiable polymer is able to generate a polymer that serves as supporting material for the at least one MALDI matrix forming compound. The at least one MALDI matrix forming compound of the kit can be covalently linked to the modifiable polymer of the kit.

These and other features of the invention will be better understood in light of the following figures and detailed description.

### BRIEF DESCRIPTION OF THE FIGURES

FIG. 1 shows a schematic comparison of the configuration of a conventional MALDI mass spectrometry (FIG. 1A) and one embodiment of a substrate and a method of the invention (FIG. 1B).

FIG. 2 depicts examples of suitable MALDI matrix forming compounds that may be used in the present invention. These compounds are able to react with a modifiable polymer to yield a composite matrix material for MALDI. (1): 2,5-dihydroxy-benzoic acid; (2): sinapinic acid; (3): 3-hydroxypicolinic acid; (4): 4-hydroxycinnamic acid; (5): 4-cyano-4-hydroxycinnamic acid methyl ester; (6): 2,4,6-trihy-droxyacetophenone; (7): 3-(7-hydroxy-1H-indol-3-yl)-2-propenoic acid; (8): 2-mer-capto-6-benzothiazole-ethanol; (9): 3-(6-bromo-1H-indol-3-yl)-2-propenoic acid ethyl ester; (10): 1,3,8-trihydroxy-6-methyl-anthrone; (11): 3-(hydroxymethyl)-1-isoquinolinone; (12): 2,3,4,5-tetrahydro-5-oxo-3-thioxo-1,2,4-triazine-6-carbonyl chloride; (13): harmol (1-methyl-9H-pyrido[3,4-b]indol-7-ol).

FIG. 3 shows examples of modifiable polymers that may be used to obtain a composite matrix material of the present invention. FIG. 3A depicts the chemical structure of a typical polymeric diglycidyl ether of bisphenol A comprised in the photoresist SU-8. FIG. 3B depicts the chemical structure of a polysiloxane, which contains side chains with chlorobenzyl moieties. FIG. 3C shows the chemical structure of a polysilane that contains side chains with ester moieties. FIG. 3D shows the chemical structure of a polysilane that contains chlorosilyl groups. FIG. 3E depicts the chemical structure of a poly(N-propargylamide), namely poly(N-propargyl-capronamide). FIG. 3F shows the chemical structure of a copolymer of styrene, methacrylic acid and methacrylamidoacetaldehyde, an example of a polymer of methacryamidoacetaldehyde. FIG. 3G shows the chemical structure of PFT, a poly(fluorenetriphenylamine). FIG. 3H shows the chemical structure of a poly(hydroxyvinylsalicylaldehyde). FIG. 3I shows the chemical structure of Lupamin, a polyvinylamine.

FIG. 4 depicts a proposed mechanism of an acid-catalyzed cationic cross-linking reaction between a polymeric diglycidyl ether of bisphenol A (comprised in SU-8) and α-cyano-4-hydroxycinnamic acid.

FIG. 5 depicts the acid-catalyzed cationic cross-linking reaction between polymethyl methacrylate and α-cyano-4-hydroxycinnamic acid.

FIG. 6 depicts mass spectra of 1-μL drops of 1 pmol/μL of the small peptid of the sequence methionine-arginine-phenylalanine-alanine (MRFA, m/z 524) solution on α-cyano-4-hydroxycinnamic acid-incorporated SU-8 films. The films contained (a) 5 mg/mL, (b) 8 mg/mL, (c) 12 mg/mL, and (d) 16 mg/mL of HCCA in SU-8 photoresist respectively. The small peaks (at about m/z 540) beside MRFA are signals originating from oxidized MRFA. The laser power was set at 85 μJ in all cases.

FIG. 7 depicts mass spectra of the small peptid of the sequence methionine-arginine-phenylalanine-alanine (MRFA, m/z 524) obtained on different probe surfaces: (a) HCCA modified SU-8 film (b) unmodified stainless steel.

FIG. 8 depicts a mass spectrum of a mixture with equal amounts (500 fmol) of MRFA (m/z 524), Bradykinin fragment (m/z 757), Angiotensin II (m/z 1046), P₁₄R (m/z 1534), and ACTH fragment 18-39 (m/z 2465) on HCCA incorporated SU-8 film.

FIG. 9 depicts a mass spectrum of a mixture with equal amounts (2 pmol) of MRFA (m/z 524), Bradykinin fragment (m/z 757), Angiotensin II (m/z 1046), and P₁₄R (m/z 1534) on 2,5-dihydroxy benzoic acid (DHB) incorporated SU-8 film.

FIG. 10 depicts a mass spectrum of a mixture containing 1 pmol caffeine (m/z 196) and 200 fmol reserpine (m/z 609) obtained on HCCA modified SU-8 film.

FIG. 11 depicts a mass spectrum of a mixture with equal amounts (2 pmol) of insulin oxidized B chain (m/z 3495) and insulin (m/z 5735) obtained from HCCA incorporated SU-8 film.

FIG. 12 shows a mass spectrum obtained from a tryptic digest of cytochrome c (800 fmol) deposited on HCCA modified SU-8 surface.

FIG. 13 depicts a mass spectrum of 2 pmol angiote nsin I (m/z 1296) obtained on HCCA modified polymethyl methacrylate film.

FIG. 14 depicts tandem mass spectra of (a) 1 pmol MRFA and (b) 500 fmol reserpine obtained by QIT/TOF on HCCA modified SU-8 film.

FIG. 15A depicts an exemplary embodiment of a device, wherein the composite matrix material 1 of the invention covers a part of the surface of a solid support 7. In the depicted embodiment the solid support 7 has the shape of a standard 96 well plate and provides recesses at the locations of the wells of a respective 96 well plate.

FIG. 15B depicts the device of FIG. 15A, loaded with analyte 3. The recesses of the device, which provide the composite matrix material 1 and are loaded with analyte, can be irradiated for mass spectrometric analysis as depicted in FIG. 1B.

### DETAILED DESCRIPTION OF THE INVENTION

As explained above MALDI matrix forming compounds are able to absorb and convert photon energy upon irradiation into energy sufficient to desorb and ionize analytes, which are in contact with the respective molecule. The present invention is based on the finding that MALDI matrix forming compounds, which are covalently linked to polymers, are able to desorb and ionize analytes. Hence, they are able to fulfil the same function as matrix particles that consist of small organic molecules.

Contrary to matrix particles consisting of small organic molecules, the MALDI matrix forming compounds of the invention are covalently linked to the composite matrix material. Therefore they cannot easily be vaporized from the polymeric network. Thus, the polymer of the composite matrix material of the invention does not merely serve as a macroscopic supporting material for the MALDI matrix forming compounds. Rather it also serves as a supporting material on a molecular level, in terms of retaining or preventing the escape of a MALDI matrix forming compound during the process of detecting analyte ions. When used in MALDI, the composite matrix material of the invention does therefore not give rise to a noise of background signals, which otherwise results from the evaporation of matrix molecules.

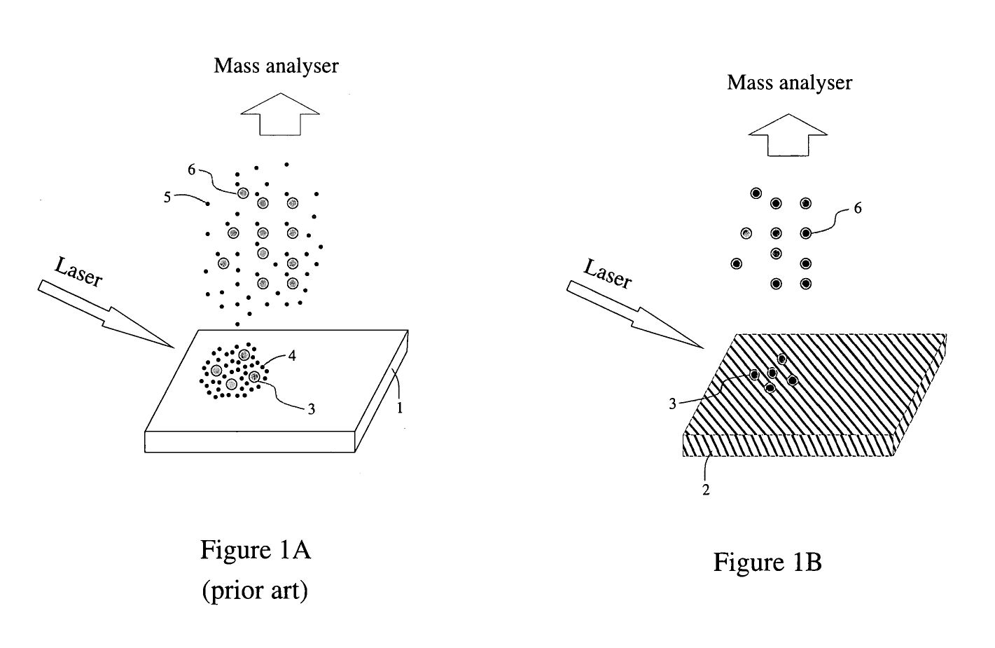

The composite matrix material of the present invention is able to generate analyte ions upon for instance irradiation by the pulsed laser of a mass spectrometer (see FIG. 1B). Depending on the one or more MALDI matrix forming compounds, the composite matrix material may be able to generate ions at any wavelength used for the pulsed laser. Accordingly, the generation of analyte ions may occur within any range of wavelengths. If desired analyte ions can be generated at a number of specific wavelengths, or at one defined wavelength within the electromagnetic spectrum. Typically, the wavelengths or ranges of wavelengths are within the range of about 12 μm to about 180 μm.

Thus, the composite matrix material of the present invention may comprise any material that is of such low reactivity under MALDI mass spectrometry conditions that essentially no reactions occur, which lead to the generation of detectable fragments in MALDI mass spectrometry. Optionally such a composite matrix material may be essentially or, if desired, completely inert under MALDI mass spectrometry conditions. As illustrated by the examples below, composite matrix materials can be selected that do not generate any detectable fragments in MALDI mass spectrometry. Typically such a composite matrix material is of solid state.

The composite matrix material of the invention may contain any ratio of the MALDI matrix forming compound and the polymer serving as supporting material, as long as it is able to generate analyte ions upon irradiation. As explained below, the respective ratio at least partially influences this ability to generate analyte ions. As a consequence, there exists typically an optimal range for the respective ratio, in which an at least conventional amount of analyte ions (when compared to MALDI using standard matrix material) is generated and at which the composite matrix of the invention can be prepared with convenient ease. It may therefore be desired to obtain such a ratio (see below for an illustrative example), and, where not yet known, to determine the respective optimal range.

In the matrix material of the present invention the one or more MALDI matrix forming compound(s) is/are linked to the modifiable polymer. Respective linkages may include any covalent bond and/or atom, which is/are stable enough to withstand an irradiation intensity that causes the composite matrix material to desorb and ionize analytes. Each molecule of the MALDI matrix forming compound may be linked to the polymer by at least one such bond. The respective linkers may thus contain various heteroatoms, i.e. atoms that differ from carbon. Examples of such atoms include, but are not limited to, nitrogen or oxygen atoms.

The at least one MALDI matrix forming compound of the composite matrix material may be any suitable compound that is able to form a MALDI matrix. A MALDI matrix forming compound is generally an organic molecule of low molecular weight. Such low molecular weight compound is usually, but not necessarily, itself suitable for usage as a MALDI matrix. Numerous compounds have been identified that can be used as a MALDI matrix. While the majority of these compounds are solid, liquid compounds such as glycerol have been employed as well. Often aromatic compounds containing an electron accepting group in resonance with the aromatic system are used as a matrix material.

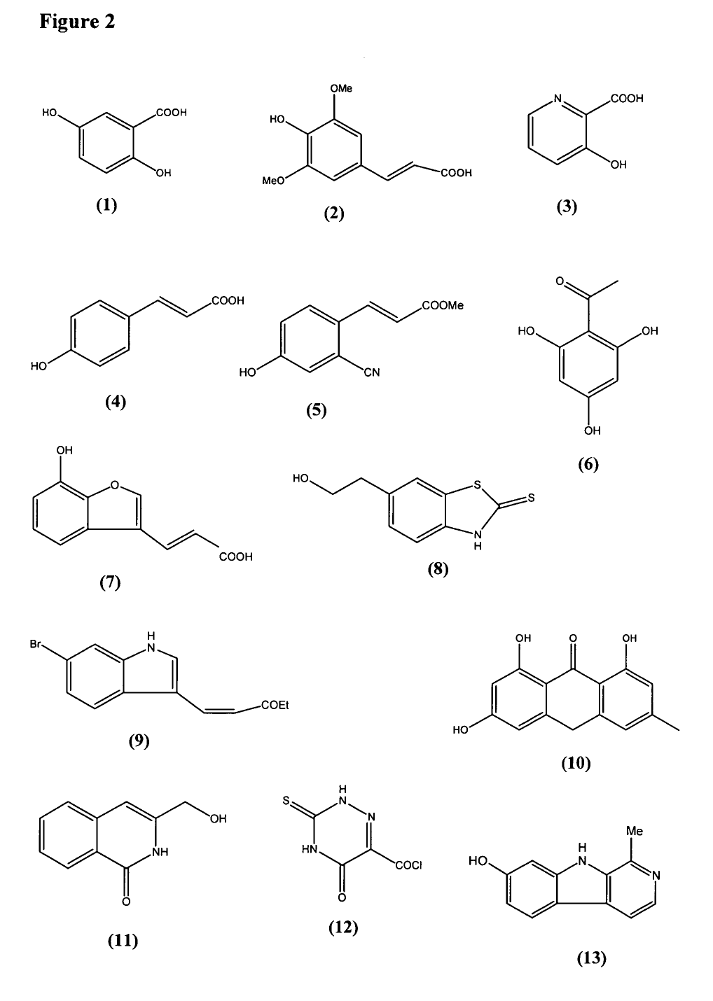

Examples of such compounds include, but are not limited to 2,5-di-hydroxy-benzoic acid, sinapinic acid, 3-hydroxypicolinic acid, 4-hydroxycinnamic acid, 4-cyano-4-hydroxycinnamic acid methyl ester, 2,4,6-trihydroxyacetophenone, α-cyano-3,4-(methylenedioxy)-cinnamic acid, 2-mercapto-6-benzothiazole-ethanol, 3-(7-hydroxy-1H-indol-3-yl)-2-propenoic acid, 1,3,8-trihydroxy-6-methyl-anthrone, 3-(hydroxymethyl)-1-isoquinolinone and harmol (1-methyl-9H-Pyrido[3,4-b]indol-7-ol) (all of which are shown in FIG. 2). Other examples include caffeic acid (3,4-dihydroxy-cinnamic acid), α-cyano-4-hydroxycinnamic acid, 2-(4-hydroxyphenylazo) benzoic acid, 4-(acetylamino)-2-hydroxy-5-(phenylazo)-benzoic acid, 2,5-dihydroxy-benzoic acid, nicotinic acid, succinic acid, ferulic acid, 3,4-dihydroxy-α-(ethylamino)-acetophenone, 6-aza-2-thiothymine, dithranol, p-nitroanilin, 2,4-dihydroxyacetophe-none, 2-hydroxybenzophenone, isovanillin, trans-3-indoleacrylic acid, t-2-(3-(4-tert-butyl-phenyl)-2-methyl-2-propenylidene)malononitrile, 1-ethyl-1,2,3,4-tetrahydro-7-methyl-4-oxo-1,8-naphthyridine-3-carboxylic acid (NDA), sulfadiazine (4-amino-N-2-pyrimidinyl-benzenesulfonamide), and N1-(5-bromo-2-pyrimidyl)-sulfanilamide, to name only a few.

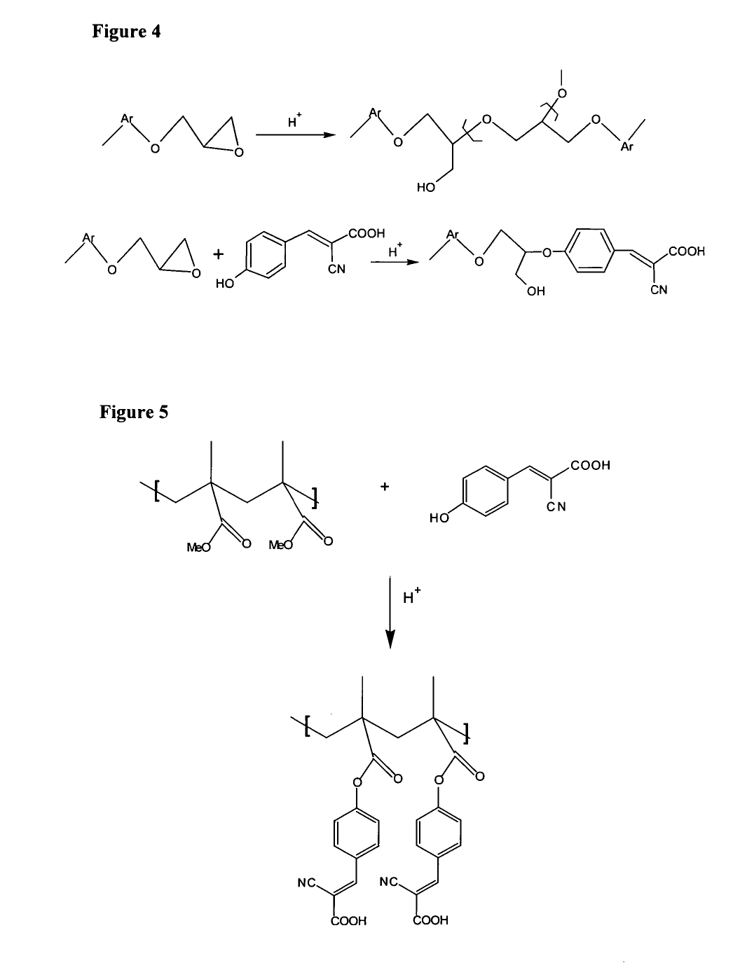

As may be inferred from the above, a compound that is suitable as a MALDI matrix contains elements that provide a chromophore for the absorption of energy. Such elements, which often include functional groups, therefore typically remain preserved when comparing a low molecular weight MALDI matrix forming compound and the respective composite material comprising said compound (see e.g. FIGS. 4 and 5). Nevertheless, any element of a MALDI matrix forming compound may be altered as long as it is able to form a MALDI matrix.

In embodiments, where the elements required for the suitability of the MALDI matrix forming compound remain unaltered, the respective compound thus contains one or more additional reactive functional group(s) when compared to the composite matrix material. Such a functional group may have a higher, a comparable or a lower reactivity than an unaltered element of the MALDI matrix forming compound (cf. below).

The respective reactive groups(s) of the MALDI matrix forming compound(s) may be any functional group, as long as its reaction does not obstruct the suitability of the compound for usage as a MALDI matrix. Examples of suitable functional groups include, but are not limited to, amino-, amido-, azido, carbonyl-, carboxyl-, cyano-, isocyano, dithiane-, halogen-, hydroxyl-, nitro-, organometal-, organoboron-, seleno-, silyl-, silano-, sulfonyl-, thio-, thiocyano, trifluoromethyl sulfonyl, p-toluenesulfonyl, bromobenzenesulfonyl, nitrobenzenesulfonyl, and methanesulfonyl.

At least one of these additional reactive functional groups present in the MALDI matrix forming compound, in the form as used as a reactant, is consequently not present in the composite matrix material as such. This is due to the fact that the above described linkers between the MALDI matrix forming compounds and the polymer are derived from a reaction of the respective functional groups of the MALDI matrix forming compound with a modifiable polymer.

The polymer of the composite matrix material may be derived from any modifiable polymer that is able to react with the above described reactive functional group(s) of the MALDI matrix forming compound. Examples of such reactions include, but are not limited to nucleophilic or electrophilic displacements. Such modifiable polymers may for instance contain side chains comprising reactive functional groups. Typically, such functional groups are photoreactive or thermally reactive. They are thus able to undergo a chemical reaction upon the application of photonic energy or heat. Examples of suitable functional groups include, but are not limited to, epoxy-, nitrilo-, ester-, amido-, carbonyl- or chlorine groups. Examples of suitable modifiable polymers include, but are not limited to, polymers of a condensation product of an epoxide and a diol, polymers of methacryamidoacetaldehyde, polyacrylates, poly(N-propargylamides), poly(O-propargylesters), polysiloxanes, polysilanes, polyfluorenes, poly(vinyl amine)s, and poly(hydroxyvinylsalicylaldehydes).

Such modifiable polymers may be of any aggregation state such as liquid, solid or any intermediate state between the two. As an example, where it is desired to obtain the composite matrix material by means of a homogenous reaction, a liquid polymer may be selected. Alternatively, in such a case a solid polymer may be dissolved in a suitable solvent (see below for an example).

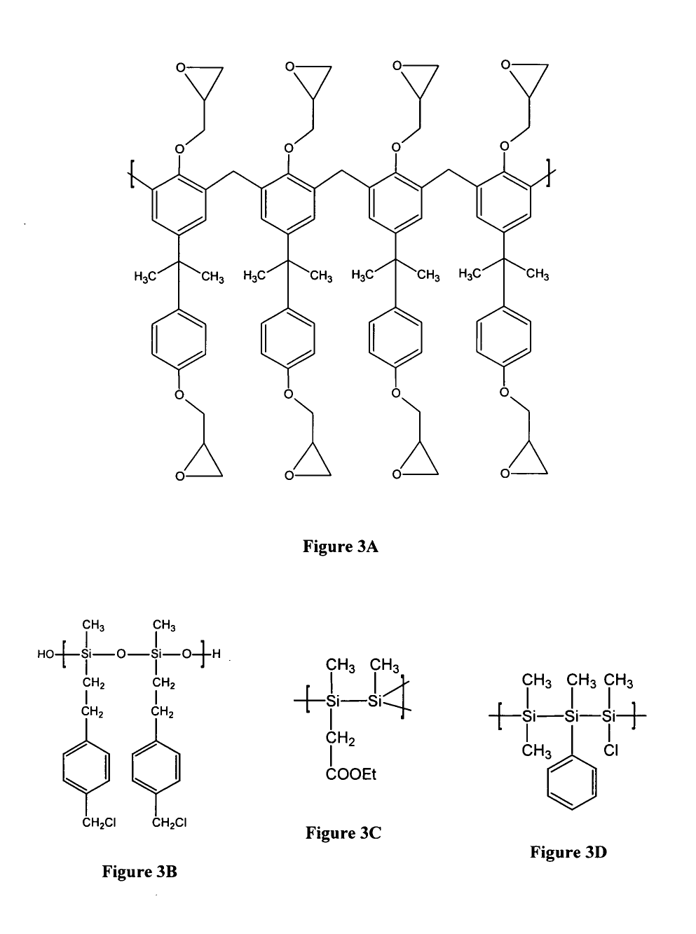

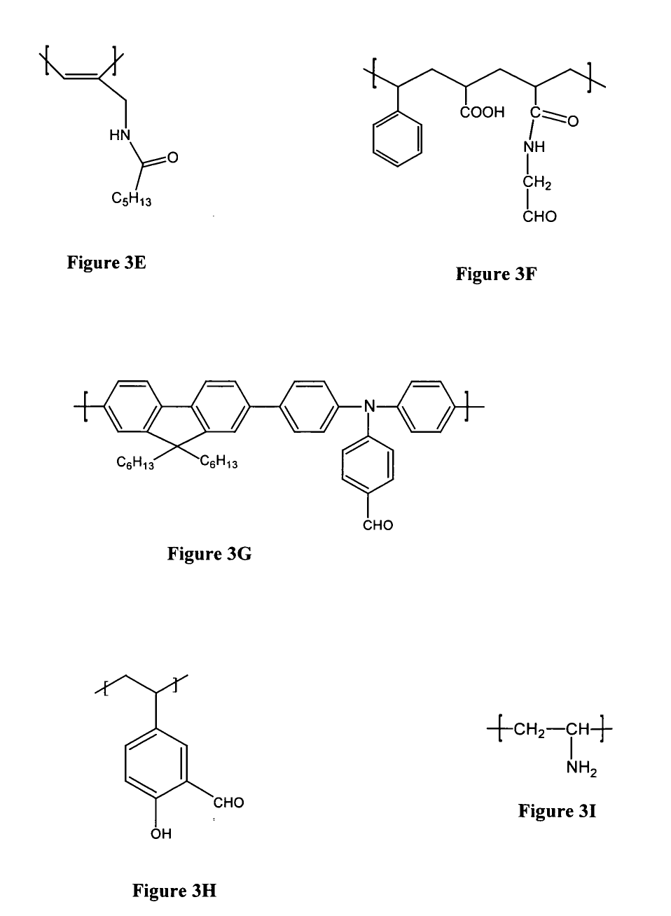

Non-limiting examples of a condensation product of an epoxide and a diol include, but are not limited to, polymers obtained from a condensation product of epichlorohydrin and bisphenol-A and polymers obtained from a condensation product of epichlorohydrin and bisphenol-F. An illustrative example of such a polymeric diglycidyl ether of bisphenol A is depicted in FIG. 3A. Respective resins are commercially available under the trade names EPON 828, EPON 1001, EPON 1009, EPON 1031, DER 331, DER 332, DER 334, DER 542, GY285 and BREN-S. In a highly branched form they are usually a component of photoresists such as SU-8. SU-8 is a chemically amplified photoresist, in which the epoxy resin is dissolved in an organic solvent containing an acidic photoinitiator. It may therefore be conveniently be used for the preparation of a composite matrix material of the present invention. Typically SU-8 is used as a negative photoresist for semiconductor fabrication in the microelectronics industry. The chemical structure of a typical diglycidyl ether of bisphenol A that is comprised in SU-8 is depicted in FIG. 3A. The epoxy functional groups of the resin comprised in SU-8 are normally polymerized by cationic ring-opening photopolymerization, which is induced by Lewis acids, the products of UV irradiation on the photoinitiator. Cured SU-8 is highly resistant to solvents, extreme pH ranges, as well as thermal and mechanical stress.

Examples of polyacrylates include, but are not limited to polymethyl methacrylate, poly(n-butyl acrylate) (PBA), and stearyloxypolyethyleneoxy-ethyl-methacrylate (SPMA). Polymethyl methacrylate (PMMA, cf. FIG. 5), also termed polymethyl-2-methylpropanoate, is a rigid, colourless, and transparent plastic, which is typically used as a substitute for glass. As such it is sold under tradenames such as ‘Acrylite®’, ‘Lucite®’ or ‘Plexiglass®’. Its properties are due to the presence of pendant methyl groups, which prevent a close packing of the polymer chain and a free rotation of the polymer chain. The chemical structure of polymethyl methacrylate can be represented by the formula: 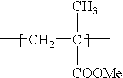
Suitable polyacrylates may also comprise terminal epoxid-groups, as for example disclosed in U.S. Pat. No. 6,747,101.

Examples of poly(N-propargylamides) and poly(O-propargylesters) include, but are not limited to, acetylene-based polymers comprising caproic ester, capronamide, 3,7-dimethyloctaneamide, 3,7-dimethyloctanoic ester, 2-methyloctane-amide, 2-ethyloctaneamide or 2-propyloctaneamide moieties, as for example described by Nomura, R, et al (J. Am. Chem. Soc., (2001), 123, 8430-8431, cf. FIG. 3E for an example) and Tabei, J, et al. (Macromol Chem Phys, (2005), 206, 323-332). Poly(N-propargylamides) have attracted attention due to their ability to form helices as well as the existence of members of this polymer class with a transition temperature, at which a change from helical conformation to random coil occurs (Deng, J, et al., Macromol Chem Phys, (2004), 205, 1103-1107).

Examples of polysiloxanes that can be used, include, but are not limited to, polysiloxanes with chlorobenzyl groups as described by Kazmierski, K, et al. (Journal of Polymer Science, Part A, 42, (2004), 7, 1682-1692; cf also FIG. 3B).

Examples of suitable polysilanes include, but are not limited to, polysilanes comprising side chains with ester moieties as described by Hatanaka, Y (Journal of Organometallic Chemistry, 685, (2003), 207-217, cf. also FIG. 3C), polysilanes comprising chlorosilano groups as described by Tang, H et al. (J. Mater. Chem., (2005), 15, 778-784 cf. also FIG. 3D), or polysilanes comprising side chains with nitro moieties (ibid.).

An example of a polymer of methacryamidoacetaldehyde is a copolymer of styrene, methacrylic acid and methacrylamidoacetaldehyde as described by Santos et al. (J. Polym. Sci. Pol. Chem., (1997), 35, 9, 1605-1610). An example illustrating a respective chemical structure is depicted in FIG. 3F.

Examples of suitable polyfluorenes include, but are not limited to, poly(fluorenetriphenylamine)s and poly(fluorene-co-N-(4-butylphenyl)diphenyl-amine)s. FIG. 3G shows poly-[N-(phenyl)-N-4-(2-(9,9-dihexyl-9H-fluorene)-phenyl)-amino-benzaldehyde] (PFT) as an illustrative example (Fang, Q, et al., Macromolecules, 37, (2004), 16, 5894-5899). Polyfluorenes are thermally stabile copolymers of typically amorphous structure, which are able to act as organic electroluminescents. Due to this property they are used in a wide range of opto-electronic devices, in particular for the manufacture of organic light emitting diodes (LEDs).

An example of a poly(hydroxyvinylsalicylaldehyde) is poly-(4-hydroxystyrene-co-5-vinyl salicylaldehyde) (cf. FIG. 3H). Poly(hydroxyvinyl-salicylaldehydes) are derivatives of polyhydroxystyrene (see below).

Examples of poly(vinyl amine)s include, but are not limited to, the linear high molecular weight polymer commercially available under the trade name Lupamin® or synthesized as described in Fischer, T and Heitz, W (Macromol. Chem Phys., (1994), 195, 679-687, cf. FIG. 3I). Poly(vinyl amine)s are watersoluble and used in the production of paper.

The covalent linkage between the polymer and the MALDI matrix forming compound is achieved by a reaction of one or more functional groups (see above) of a modifiable polymer, from which the polymer of the composite matrix material is derived. Accordingly, the linker between these two components typically contains one or more N- or O-atoms. Examples of linkers containing an oxygen atom include, but are not limited to esters or ethers. Examples of linkers containing a nitrogen atom include, but are not limited to amides or amines. FIGS. 3 and 4 illustrate two embodiments of linkers containing an oxygen atom as well as respective modifiable polymers and compounds, from which the MALDI matrix forming compound may be derived.

The above described linkers between the MALDI matrix forming compounds and the modifiable polymer are derived from a reaction of the respective functional groups of the said modifiable polymer with a MALDI matrix forming compound. Similarly to the MALDI matrix forming compound, at least one of the reactive groups present in the modifiable polymer is therefore not present in the polymer of the composite matrix material as such.

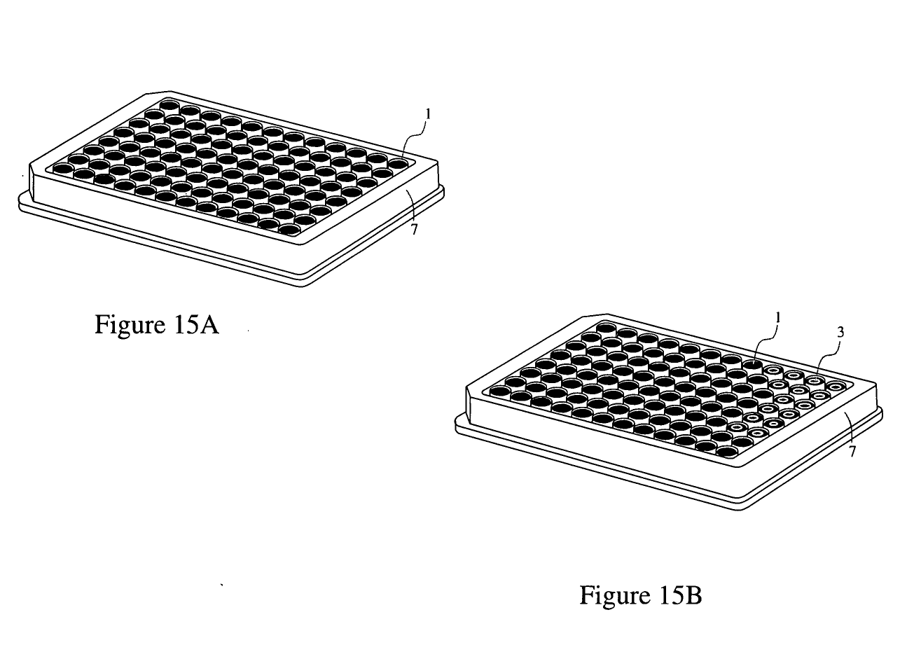

The composite matrix material of the present invention may be used in any form. It may for example be a compact module, such as a plate, a brick or a disk. Such a module may be of any desired form. It may thus as an example match the microtitre plate (MTP) format, where a compatibility to existing laboratory robots is desired. Alternatively, the composite matrix material may for instance form a film, which is located on a solid support such as a block, a disk or a plate. The respective film may cover any area of a respective support. Examples thus include, but are not limited to, a film surrounding a respective support or a film covering a top layer of a support. Another example is a solid support in the microtitre plate (MTP) format. In this case the composite matrix material may cover the areas (whether recessed or not), where on a conventional 48-, 96-, 384- or 1536 well plate the respective wells are located (see FIG. 15 for an example). Examples of materials, which such a solid support may comprise, include, but are not limited to, a metal, quartz, glass, silicone, a plastic, a polymer, a ceramic, an insulator, a semiconductor, organic material, inorganic material and composites thereof. Thus the composite matrix material may form a part of a device that may provide an integral module of not only a mass spectrometer, but also other devices, such as sample collectors or sample filling robots, which are well known to those skilled in the art.

The invention also provides a kit, which includes the above described components of the composite matrix material. It thus includes one container that includes the above described compound(s) that generates or is a MALDI matrix forming compound. The kit also includes a second container which comprises at least one modifiable polymer. By means of the kit the composite matrix material that comprises (a) MALDI matrix forming compound(s) and (a) polymer(s) that serve(s) as supporting material for the MALDI matrix forming compound can be formed. Such a kit may be of used for any desired purpose, for example, as an analytical MALDI kit for the analysis of an analyte. Depending on the components selected for the kit, such a kit may also be selective or especially suitable for certain forms of an analyte, for example for aqueous solutions. A respective selection may also provide a kit that is selective or especially suitable for certain types of analyte molecules. Two illustrative examples are a kit for the analysis of nucleic acids or for the analysis of peptides.

A respective kit may also include analytes. Such a kit may for instance be a calibration kit or serve the generation of a standard curve for semi-quantitative analysis. Another optional component of a respective kit is a solid support. The at least one MALDI matrix forming compound and the at least one modifiable polymer may be deposited on such a support in order to generate a composite matrix material. As an example, the usage of a respective kit may result in the formation of a film, located on a solid support.

The invention is also directed to a process for preparing a composite matrix material for MALDI. This method includes reacting at least one MALDI matrix forming compound and at least one modifiable polymer. As indicated above, the compound(s) that generate MALDI matrix forming compound(s) are typically themselves suitable for usage as a MALDI matrix. The term “MALDI matrix forming compound” as used herein thus refers to both a component of the composite matrix material of the invention as well as its precursor in form of a reactant used for its generation. During the process of the invention the modifiable polymer generates a polymer, which serves as supporting material for the at least one MALDI matrix forming compound.

The process for preparing a composite matrix material for MALDI leads to the formation of a covalent linkage between said at least one compound and said modifiable polymer. The process may include steps such as mixing the modifiable polymer and the compound(s) generating MALDI matrix forming compound(s), and heating a respective mixture. Examples of respective reactions include, but are not limited to nucleophilic substitution reactions, electrophilic substitution reactions, free-radical substitution reactions, nucleophilic additions and electrophilic additions. Such reactions may include the usage of one or more catalysts, which may for instance be an acid or a base.

As indicated above, the compound used to generate the MALDI matrix forming compound of the composite matrix material may itself be suitable as a MALDI matrix. In this case the suitability for usage as a MALDI matrix will typically be preserved during the process of the invention. This can be achieved by selecting a chemical reaction that preserves the respective underlying molecular structure (see above for examples). As an example, where an aromatic ring and an electron accepting group provide the structural elements required for the suitability as a MALDI matrix, these elements are preserved. Chemical reactions that change this underlying structure, as for instance in the above example a radical polymerization, will thus be avoided.

FIGS. 4 and 5 illustrate two exemplary reactions between a modifiable polymer and a low molecular weight compound that is itself suitable for usage as a MALDI matrix. Such a cross-linking reaction may for instance be a cationic acid-catalyzed reaction, as indicated in the reaction schemes of FIGS. 4 and 5. As a further illustration, the steps involved in the reaction depicted in FIG. 4 shall be briefly addressed. The respective scheme shows the modification of a polymeric diglycidyl ether of bisphenol A, as comprised in SU-8, with α-cyano-4-hydroxycinnamic acid. The reaction (cf. also example 1) is typically performed in two steps: Upon UV exposure, the photolysis of thermally stable photoinitiators, such as triphenylsulfonium hexafluoroantimonate onium salts, produce strong acids. These act as catalysts to initiate the cross-linking reaction. The second step, the so called ‘post expose bake’ (PEB), thus comprises an acid-initiated, thermally driven epoxy cross-linking of molecules of the epoxy resin to form a polymer network. At the same time, α-cyano-4-hydroxycinnamic acid can be covalently bonded to the polymeric structure. Epoxides, as the reactant depicted in FIG. 4, are a highly reactive functionality, to which additional functional group(s) can be introduced by opening the epoxide rings.

Any compound, which is able to be or generate a MALDI matrix forming compound, may be used for the preparation of a composite matrix material of the present invention, as long as it is able to react with a modifiable polymer. The underlying ability of the respective MALDI matrix forming compound to desorb and ionize other molecules may occur upon irradiation at a certain wavelength or at a plurality of wavelengths within any range of the electromagnetic spectrum. Examples of ranges of the electromagnetic spectrum that may be chosen are visible light, ultraviolet light or infrared light.

As mentioned above, compounds may be selected, which are themselves suitable as matrix molecules. Exemplary compounds, which are suitable as matrix molecules include, but are not limited to, nicotinic acid, 3-hydroxypicolinic acid, 4-hydroxycinnamic acid, 6-aza-2-thiothymine (Lecchi P, et al., Nucleic Acids Res. 23, (1995), 7, 1276-1277), isovanillin trans-3-indoleacrylic acid or harmane (1-methyl-9H-Pyrido[3,4-b]indole, Aribine). Some of these matrix molecules, e.g. 3-hydroxypicolinic acid, 4-hydroxycinnamic acid or isovanillin may be used in the preparation of the composite matrix materials of the present invention due to their ability to absorb and convert photon energy. Other matrix molecules such as 3-indoleacrylic acid, nicotinic acid or harmane do not contain functional groups that are available for a modification reaction with a modifiable polymer such as for instance SU-8 or polymethyl methacrylate. Therefore, derivatives of such matrix molecules, which contain an additional reactive moiety, may instead be employed, provided that the reactive moiety does not obstruct the suitability for usage as a matrix material for MALDI. Examples of suitable compounds that may be used in a reaction with a modifiable polymer to obtain polymers of the present invention include, but are not limited to, 7-hydroxy-3-indoleacrylic acid, 6-aza-2-thiothymine, 2-hydroxynicotinic acid, 2-(bromomethyl)-3-pyridinecarboxylic acid and harmol (1-methyl-9H-pyrido[3,4-b]indol-7-ol). Some of these compounds are also illustrated in FIG. 1 (cf. also para 16).

The term “derivative” as used herein thus refers to a compound which differs from another compound of similar structure by the replacement or substitution of one moiety by another. Respective moieties include, but are not limited to atoms, radicals or functional groups. For example, a hydrogen atom of a compound may be substituted by alkyl, carbonyl, acyl, hydroxyl, or amino functions to produce a derivative of that compound. Respective moieties include for instance also a protective group that may be removed under the selected reaction conditions.

The at least one MALDI matrix forming compound may optionally include additional functional groups, as long as these do not prevent the formation of a covalent linkage to the modifiable polymer under the respective reaction conditions selected. As indicated above, these additional functional groups may be of any reactivity when compared to an unaltered element of the MALDI matrix forming compound (see above). It may be desired to use compounds comprising additional functional groups, which have a lower or comparable reactivity than an element within the structure required for the suitability as a MALDI matrix. This can be achieved by the use of protective groups, which is a well established method in the art. Using this approach, said group within the structure required for the suitability as a MALDI matrix is shielded from participating in the reaction of the linkage process. If it is for instance desired to employ a compound with a firther carboxylic group in addition to a carboxylic group as part of the structure required for the suitability as a MALDI matrix, the latter carboxylic group may be shielded by converting it into an ester. Where the group to be preserved is a hydroxyl group, it may for instance be protected by an isopropylidene group. Such protective groups may be removed after the reaction of the linkage process and the structure required for the suitability as a MALDI matrix thus be preserved. For example, the isopropylidene protective group shielding a hydroxyl group may be removed by acid treatment. Those skilled in the art will furthermore be aware that such protective groups may have to be introduced well in advance during the synthesis of the respective compound.

As already indicated above, any ratio of the compound generating the MALDI matrix forming compound and the modifiable polymer may be employed, as long as the obtained composite matrix material is able to generate analyte ions upon irradiation. This ability to generate analyte ions is dependant on the respective ratio. The amount of said compound incorporated into the composite matrix material affects the degree of its capability to absorb and convert photon energy upon irradiation into energy sufficient to desorb and ionize molecules which are in contact with the composite matrix material. Thus in one aspect the suitability of the obtained composite matrix material for MALDI depends on the amount of the respective MALDI matrix forming compound(s) incorporated into the modifiable polymer. In another aspect the sensitivity of a MALDI analysis, performed with the respective composite matrix material, depends on the incorporated amount of said compound. If necessary, a suitable ratio can be identified experimentally.

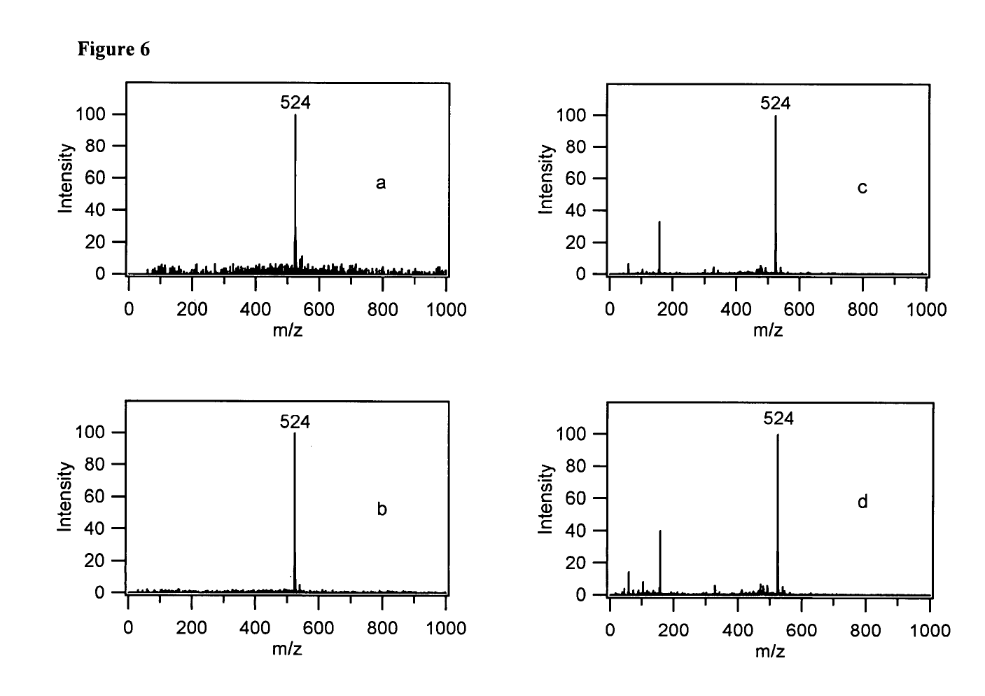

An excess of a MALDI matrix forming compound present in the composite matrix material may lead to their incomplete incorporation into the polymeric network of the modifiable polymer. As an example, SU-8 may be used as the source of a modifiable polymer and α-cyano-4-hydroxycinnamic acid (HCCA) may be used as a MALDI matrix forming compound for modification. Irradiation may be performed by means of a 337-nm nitrogen laser with 3-ns pulse width. In this case ions derived from non-reacted α-cyano-4-hydroxycinnamic acid are typically observed at HCCA loadings above 8 mg/ml (cf. also FIG. 6). As a further illustration, a composite matrix material may be obtained from SU-8 as the source of a modifiable polymer and 2,5-dihydroxy benzoic acid (DHB) as the MALDI matrix forming compound. Using the above indicated irradiation source no ions derived from DHB have been observed at a ratio of DHB/SU-8 composite of about 15 mg/ml.

The modifiable polymer may itself be able to absorb photon energy upon irradiation, as long as it does not prevent the ability of the final polymer product of the invention, to be suitable as a matrix material for MALDI. Polymeric diglycidyl ethers of bisphenol A, as comprised in SU-8, have for example themselves a high actinic absorption below 350 nm. This may even assist the rapid distribution of irradiation energy on the modified polymer surface, with the effect of securing that no breakage of the covalent bonds between anchored low molecular weight compounds and the modifiable polymer may occur.

The modifiable polymer used may comprise a straight or branched backbone or be modified in e.g. a cross-linking reaction. It may be of any chain length and be of liquid or solid aggregate state, or of an intermediate state between them. The groups of the modifiable polymer are typically located in its side chains. Examples of such reactive groups include, but are not limited to, epoxy-, nitrilo-, ester-, amido-, carbonyl- or chlorine groups. Examples of respective modifiable polymers include, but are not limited to, polymers of a condensation product of an epoxide and a diol, polymers of methacryamidoacetaldehyde, polyacrylates, poly(N-propargylamides), poly(O-propargylesters), polysiloxanes, polysilanes, polyfluorenes, poly(vinyl amine)s, and poly(hydroxyvinylsalicylaldehydes) (see above).

It should furthermore be noted that the modifiable polymer that is employed to react with said compound(s) generating the MALDI matrix forming compound(s) may itself be obtained in a reaction with or within another polymer. Examples of obtaining a polymer by the latter process are used in the formation of blends, as for instance the blending of PMMA with rubber modifiers. Such an example is the polymerisation of methyl methacrylate (MMA), dissolved in an ethylene-vinyl acetate (EVA) copolymer (Cheng, S K, Chen, C Y, European Polymer Journal, 40, (2004), 6, 1239-1248). EVA/PMMA blends can thus be obtained, which are suitable as a modifiable polymer for the present invention.

Another example of obtaining a suitable modifiable polymer from another polymer is the application of a modification reaction. An example of such a reaction is known as the “Reimer-Tiemann” reaction. It comprises the reaction of a phenolic polymer with chloroform, which results in the introduction of aldehyd functions to the phenol ring. Using this reaction, polyhydroxystyrenes may for instance be converted into poly(hydroxyvinylsalicylaldehydes) (see e.g. Aronson, L, et al., Polymer Bulletin, 52 (2004), 409-419).

Another example of such a modification reaction is an exposure of a polymer to a radiofrequency glow discharge ammonia plasma or a low-pressure non-isothermal glow discharge oxygen plasma. A respective functionalisation of poly(tetrafluoroethylene) (Teflon) with amino groups in form of a surface treatment has for example been disclosed by Gauvreau, V, et al. (Bioconjugate Chem., (2004), 15, 1146-1156).

Examples of polymers that may be subjected to a modification reaction include, but are not limited to poly(tetrafluoroethylene), polystyrene or polymers of a condensation product of a phenol and an aldehyde. Three non-limiting example of a condensation product of a phenol and an aldehyde are phenol-formaldehyde-, cresol-formaldehyde- and xylenol-formaldehyde resins. Such resins are classified into resols and novolacs, the main difference being the condensation degree. While resols are generated by terminating the polycondensation at a selected condensation degree, novolacs are obtained when the polycondensation is brought to completion. Both resols and novolacs are used for coatings and paints.

As numerous MALDI matrix forming compounds and numerous modifiable polymers can be used for the composite matrix material of the present invention, it is possible to select an embodiment where a high analyte concentration is achieved. It may for instance be desired to obtain a composite matrix material that repels the analyte sample so that a spreading out of analyte sample is averted, in particular where the sample is a fluid. The following may serve as an illustration. The composite matrix materials of the present invention may be hydrophilic or hydrophobic, so that they may be selected to be of a hydrophilicity opposed to the analyte. For example, where the analyte is provided in an aqueous solution, a hydrophobic composite matrix material will generally lead to a shrinking of analyte sample spots applied thereon. Where the analyte is for example provided in a hydrophobic organic solvent, a hydrophilic composite matrix material will generally have a similar effect on analyte sample spots applied thereon. As a result, the detection sensitivity of the MALDI method (see below) will increase. Examples of a polymer with a hydrophobic surface are polymers obtained by a modification reaction using SU-8 as the source of a modifiable polymer.

Where desired, the method of the invention may furthermore include steps of fabricating the composite matrix material into different patterns of micrometer or submicrometer sizes using photolithography technique. Such micro-patterns may for example be used as MALDI support/substrate in proteome analysis (see below).

In another aspect of the invention, there is provided a method for providing an analyte ion, which is suitable for analysis by MALDI mass spectrometry. This method allows for determining the mass to charge ratio (m/z) of analyte ions and/or fragments thereof. The method includes providing a composite matrix material comprising at least one MALDI matrix forming compound and a modifiable polymer which serves as supporting material for the at least one MALDI matrix forming compound, wherein the MALDI matrix forming compound is covalently linked to the modifiable polymer. The method further includes contacting an analyte with a composite matrix material. Any amount of analyte may be used that will is sufficient to generate analyte ions. The minimum amount required depends on both the analyte used and the selected components of the composite matrix material. Without the intent of limiting the amount of sample used, but as an illustration, typically attomole to femtomole levels of analyte have been found sufficient in the mass spectrometric analysis using the method of the invention.

Any form of contacting the analyte and the composite matrix material may be used. As an example, the analyte may be spotted onto the polymer, for instance by means of a pipetting device using disposable tips. As another example, the analyte may be continuously disposed in form of a string, when for instance provided by liquid chromatography. Alternative mans of contacting the analyte and the composite matrix materials of the invention include the usage of automated laboratory devices, for instance providing a micro spotter.

In some embodiments the contacting of analyte and composite matrix material may form part of a sample preparation procedure that aims to increase the analyte concentration or to remove salts. Such procedures are standard methods currently used in the art and may be performed by a commercially available robot. Steps of such methods may also include washing or purification on the composite matrix material, using for example so called “ZipTips” or microcolumns.

The method of the invention may be applied to any desired analyte from which ions can be derived. Examples of such analytes include, but are not limited to, nucleotides, polynucleotides, nucleic acids, amino acids, peptides, polypeptides, proteins, synthetic polymers, biochemical compositions, organic chemical compositions, inorganic chemical compositions, lipids, carbohydrates, combinatory chemistry products, drug candidate molecules, drug molecules, drug metabolites, cells, microorganisms and any combinations thereof. The analyte may originate from any source. Therefore, the analyte may be obtained via preparative or analytical methods.

In this respect the method of the invention may be combined with such analytical and preparative methods, as for instance electrophoresis methods (see e.g. Mok, M L S et al, The Analyst, (2004), 129, 109-111) or other chromatography methods. Examples of such methods are gel filtration, ion exchange chromatography, affinity chromatography, hydrophobic interaction chromatography or hydrophobic charge induction chromatography. Non-aqueous chromatography methods such as countercurrent chromatography may likewise be combined with the method of the invention.

Chromatographic methods may furthermore be performed in form of for instance HPLC or FPLC. Other analytic and preparative methods include isoelectric focusing, electrochromatographic, electrokinetic chromatography and electrophoretic methods. Examples of electrophoretic methods are for instance Free Flow Electrophoresis (FFE), Polyacrylamide gel electrophoresis (PAGE-), Capillary Zone or Capillary Gel Electrophoresis. The combination with such methods may include a common step or a common device. As an example, a separation of proteins may be performed on a micro chip, for instance by isoelectric focussing. The respective micro chip may be coated with a film of the composite matrix of the invention. The proteins may then be analysed during or after their separation by mass spectrometry. Composite matrix materials of the present invention may also be applicable as chromatography matrices and thus be used for the preparation of columns. Where a column of a suitable material is used, the method of the invention may in such cases be used for real time detection purposes, for instance in gas chromatography.

As an example, the method of the present invention thus also provides an alternative to the currently employed coupling of on-line liquid chromatography and tandem mass spectrometry (known as LC-MS/MS), which is based on electrospray ionization (ESI) or atmospheric pressure chemical ionization (APCI) techiques. Hence, the method of the current invention thus also extends the applicability of the LC-MS/MS technique to off-line LC-MALDI-MS. It permits for instance the analysis of samples that are not suited for electrospray, or that require a tedious and time consuming preparation. Examples of such samples include, but are not limited to, samples containing proteins that require the presence of salts or detergents (e.g. membrane proteins) for their solubility. This off-line LC-MALDI-MS consumes only part of the sample by laser irradiation and the reminded sample can be stored for further analysis.

Various means may be used to assist contacting the analyte and the composite matrix material. An example of such a means is the use of patterns of micrometer or submicrometer sizes within the composite matrix material (see above). As an illustrative example, such patterns may provide an advantage for proteome analysis using LC-MALDI-MS. The micro-patterns may be used as MALDI support/substrate in the proteome analysis. As indicated above, peptides or proteins of proteome sample may for example be separated using liquid chromatography. The eluted peptide or protein may then be spotted directly on to the patterned polymer composite for MALDI mass spectrometry analysis

Analytes may be used in any form, such as for example a solid, a liquid, a suspension or solution. They may also be employed in form of a library. Examples of such libraries are collections of various small organic molecules, chemically synthesized as model compounds, or nucleic acid molecules containing a large number of sequence variants. As an example, the composite matrix material may form a film covering distinct spots on a solid flat support, for instance resembling the arrangement of a 96 well plate (cf. e.g. FIG. 15A). In this case each compound of such a library may be disposed as an analyte onto one spot of the composite matrix material (cf. e.g. FIG. 15B). The respective compounds may be disposed in an automated way by a commercially available laboratory robot.

The method further comprises irradiating the composite matrix material which is contacting the analyte. The irradiation is typically applied at the site where the contact of analyte and composite matrix material occurs, for instance where the analyte is spotted. Any irradiation may be selected that is of a strength sufficient enough to desorb and ionize the analyte. Typically the irradiation is achieved by means of a pulsed laser, which may be an integrated part of a mass spectrometer or comprised in a separate device. The person skilled in the art will be aware of the fact that the selection of the wavelength (UV or IR) used generally affects the pattern of the obtained mass spectrum and thus the information obtained by the analysis. The choice of the MALDI matrix forming compound usually depends on the selected wavelength. Subsequently, the generated analyte ions are analysed by mass spectrometry. As indicated above, the detection sensitivity of the respective mass spectrometric analysis is typically at least in the range of attomole to femtomole levels.

Examples of mass spectrometry methods that may be used include, but are not limited to, time of flight, quadrupole, ion trap, fourier transform mass spectrometry and a combination thereof.

It is standard practice in MALDI analysis to perform automated sample analysis. This means that both the irradiation and the analysis occur in an automated way by a mass spectrometer, for instance using so called “macros” based on algorithms. In the same manner, a preselection of surface areas or a search for surface areas covered with analyte can be programmed in advance. Since the method of the present invention may use any form of contacting the analyte and the composite matrix material, it may make use of these standard means of automation. In embodiments, where a form of irradiation is used, which is not provided by a mass spectrometer, the radiation source and the mass spectrometer are typically operated in a coordinated way. This generally allows for an automated operation that resembles current automated sample analysis.

Thus, in some embodiments all steps of the method of the invention may be repeatedly performed in an automated way, using for instance commercially available robots and a programmed mass spectrometer.

The invention is further illustrated by the following non limiting examples.

### EXEMPLARY EMBODIMENTS OF THE INVENTION

An exemplary embodiment of a device and method of the invention is shown in FIG. 1B. It is compared to the configuration of a conventional MALDI mass spectrometry shown in FIG. 1A.

FIG. 1A: On a metal plate 1 an analyte 3 has been mixed and cocrystallized with matrix 4. A laser beam irradiates the mixture, vaporizing and ionizing matrix molecules, thus generating matrix ions 5. These ions carry with them molecules of the analyte, whereupon these become ionized and form analyte ions 6. The generated ions can subsequently be detected with a mass analyser. FIG. 1B: An analyte 3 is contacted with the composite matrix material of the invention 2. A laser beam irradiates the composite matrix material 2, whereupon analyte molecules are vaporized and ionized. The analyte ions 6 can subsequently be detected with a mass analyser. It should be noted that in the configuration shown in FIG. 1B no matrix ions 5 are being generated.

All peptides and chemicals were purchased from Sigma (St. Louis, Mo., USA) unless noted otherwise. SU-8 2002 and PMMA photoresists were purchased from MicroChem Corp. Cytochrome C trypsin digest was obtained from LC Packings.

### EXAMPLE 1

### Preparation of α-cyano-4-hydroxycinnamic acid (HCCA) Modified SU-8 Film

This example illustrates the preparation of a film of α-cyano-4-hydroxycinnamic acid (HCCA) modified SU-8 (see FIG. 4 for a reaction scheme).

The HCCA modified SU-8 sample plates were prepared on a glass substrate according to the instructions from MicroChem with slight modifications. Prior to use, the glass surface was cleaned in a boiling Piranha solution (H₂SO₄ (%): H₂O₂ (%)=3:1) for 10 min, rinsed in deionized (DI) water and dried under gaseous nitrogen. The glasses were then dehydrated by baking on a hot plate (120° C.) for 10 min to remove residual water molecules. To prepare the HCCA-doped SU-8 sample supports, HCCA was first mixed with SU-8 2002 photoresist with strong stirring. The mixture was then spin-coated on the glass substrate with film thicknesses of 3 μm and baked on a hotplate at 65° C. for 1 min, followed by 95° C. for 2 min. The hotplates used in this study were carefully adjusted to a horizontal position before baking as the flatness of the film is affected by the gravitational force. A high-dose, near-UV exposure (200 mJ cm⁻²) was then used to activate the photosensitive compounds to initiate cross-linking. Finally, post expose bake (PEB) was carried out at 65° C. for 2 min and 95° C. for 4 min to remove residual organic solvent and to completely cross-link the polymer film. The sample support was ready for MS analysis after rinsing in DI water and drying under nitrogen gas.

### EXAMPLE 2

### Preparation of HCCA (α-cyano-4-hydroxycinnamic acid) Modified polymethyl methacrylate (PMMA) Film

This example illustrates the preparation of a film of α-cyano-4-hydroxycinnamic acid (HCCA) modified polymethyl methacrylate (PMMA, see FIG. 5 for a reaction scheme).

The HCCA modified PMMA sample plates were prepared on a glass substrate. Prior to use, the glass surface was cleaned in a boiling Piranha solution (H₂SO₄ (%):H₂O₂ (%)=3:1) for 10 min, rinsed in deionized (DI) water and dried under gaseous nitrogen. The glasses were then dehydrated by baking on a hot plate (120° C.) for 10 min to remove residual water molecules. To prepare the HCCA modified PMMA sample supports, HCCA was first mixed with PMMA photoresist with strong stirring. The mixture was then spin-coated on the glass substrate with film thicknesses of ˜1 μm and baked on a hotplate at 180° C. for 1 min, followed by 170° C. for 30 min. The sample support was ready for MS analysis after rinsing in DI water and drying under nitrogen gas.

### EXAMPLE 3

### MALDI-TOF mass spectrometry using HCCA (α-cyano-4-hydroxy-cinnamic acid) Modified polymer Films

This example illustrates the usage of α-cyano-4-hydroxycinnamic acid (HCCA) modified polymer films for MALDI-TOF mass spectrometry.

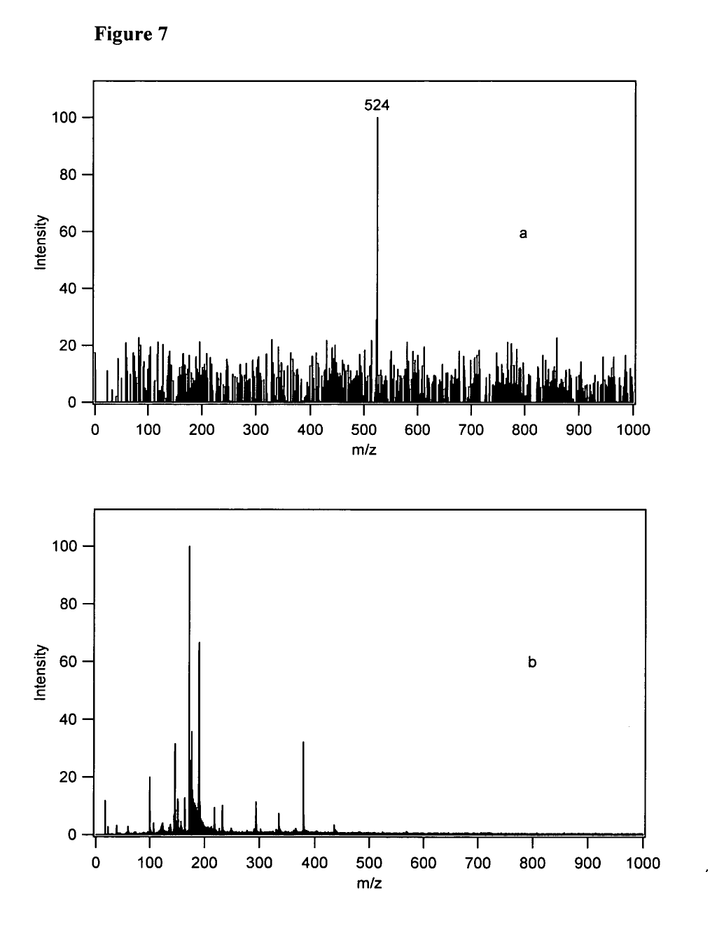

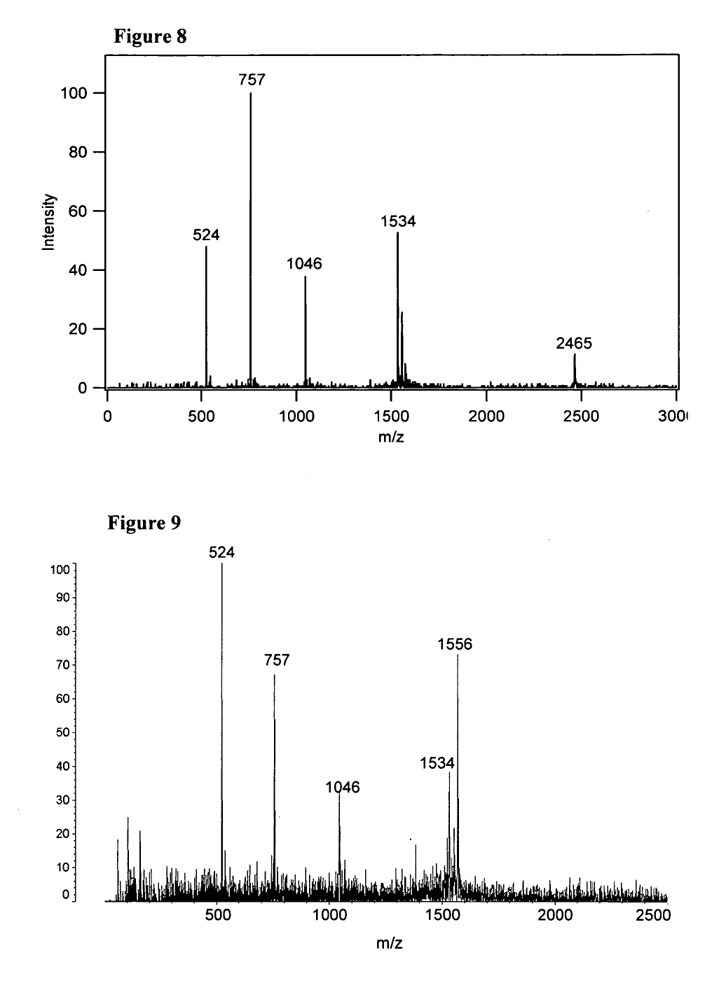

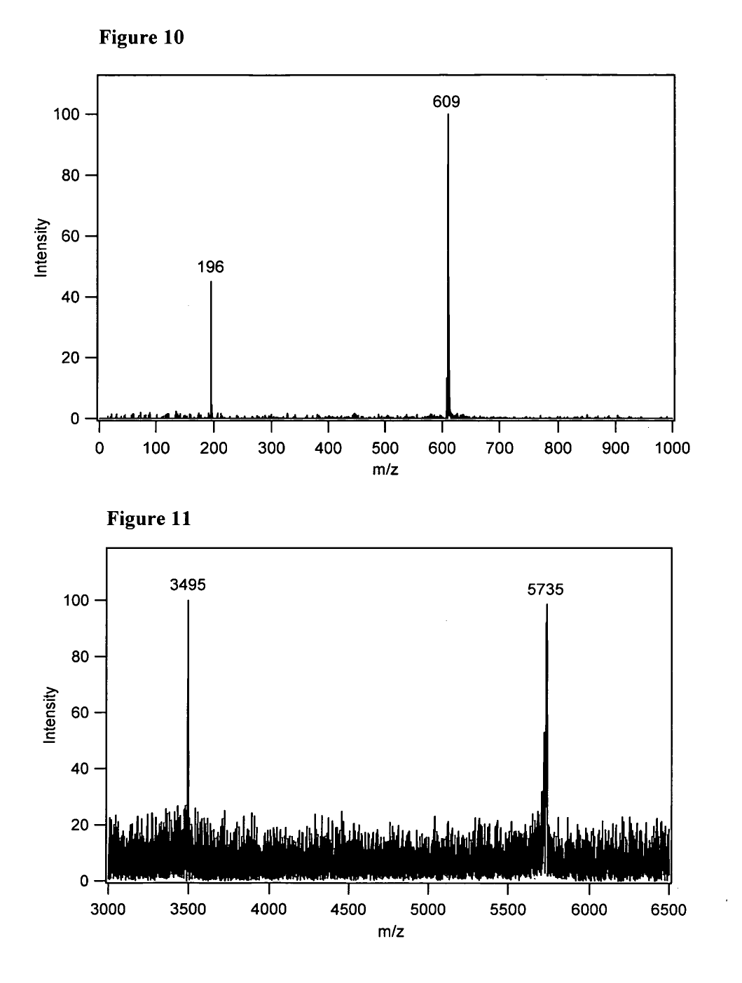

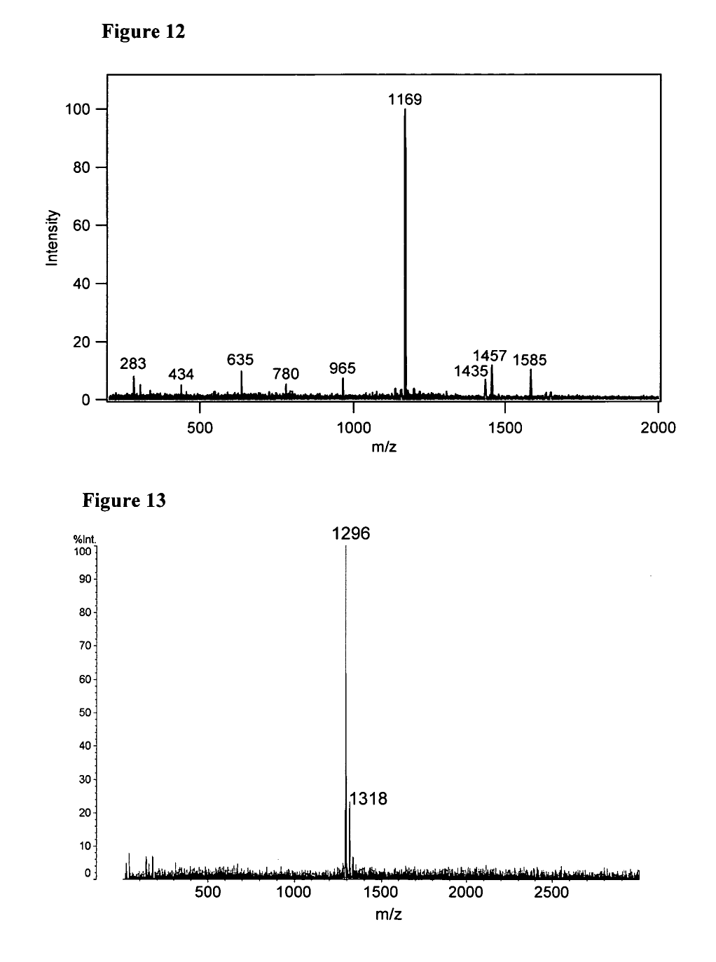

MALDI-TOF-MS experiments were performed with a Kratos Axima CFRplus (Shimadzu Biotech, Manchester, U.K.) operating in positive ion mode. Desorption/ionization was obtained with a 337-nm nitrogen laser with 3-ns pulse width. Accelerating potential was set to 20 kV. Acquisitions were accumulated with 5 laser shots at each location, and the number of laser shots used to obtain each spectrum was in the range of 50-200. The mass calibration was performed with an external standard. The HCCA modified polymer supports were attached to the MALDI target plate with conductive tape, and aliquots of 1 μl of sample solution were directly spotted onto the polymer surface. For conventional MALDI analysis, 0.5 μl of matrix HCCA (10 mg/ml in 0.1% trifluoroacetic acid/acetonitrile (1:1 v/v)) was deposited on a stainless steel sample plate, followed by 0.5 μl of analytes and dried in air. Illustrative examples of obtained mass spectra are depicted in FIGS. 6, 7A, 8 and 10 to 13.

### EXAMPLE 4

### Tandem Mass Spectrometry Using HCCA (α-cyano-4-hydroxycinnamic acid) Modified Polymer Films

This example illustrates the usage of α-cyano-4-hydroxycinnamic acid (HCCA) modified polymer films for tandem mass spectrometry.

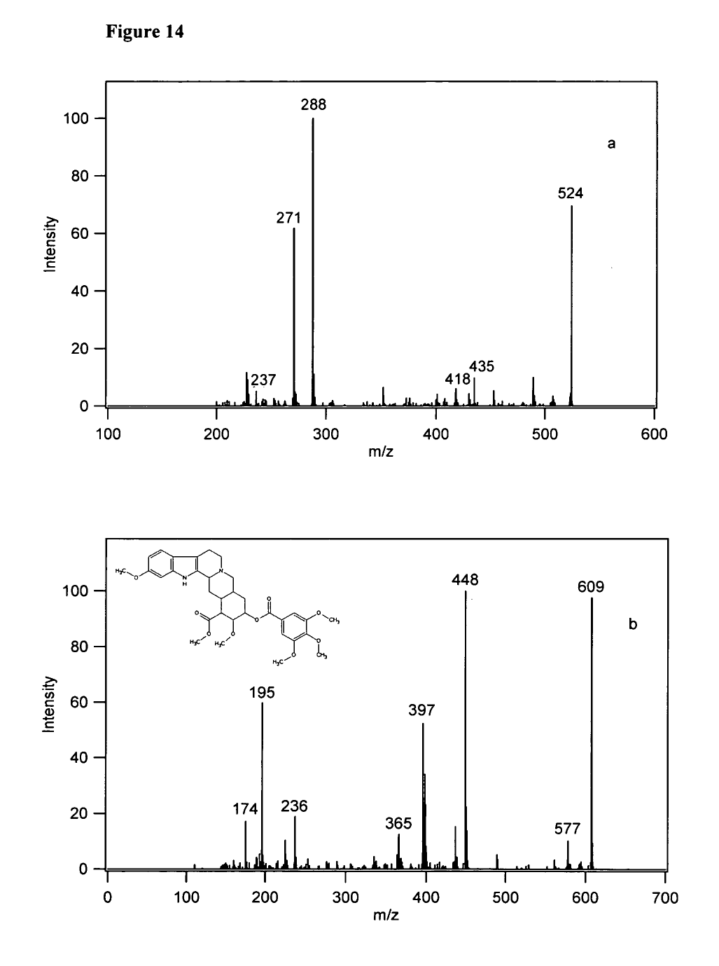

Tandem MS experiments were conducted with a Kratos Axima QIT, externally calibrated with fullerite clusters daily. The instrument consists of four main components: the ion source, the introduction region, the ion trap and the reflection TOF mass analyzer. LDI of analytes is achieved with a nitrogen laser (337 nm, 3-5 ns peak width full width half maximum). Each profile was composed of the accumulation of two laser shots. Analyte ions were then directly transferred into a quadrupole ion trap. After ions were collisionally cooled in the ion trap using suitable combinations of argon and helium gases, they were ejected and analyzed by a reflection TOF mass analyser. Prior to MS/MS analysis, precursor ions can be isolated in ion trap using the filtered noise field waveforms, which generates a notched broadband signal composed of frequency components. Argon gas was then pulsed to impose collisional activated fragmentation. In both the MS and the MS/MS modes, ions were pulsed into the TOF tube with an accelerating voltage of 10 kV. Spectra were obtained with the standard instrument settings for optimum transmission for low mass. Two exemplary mass spectra are depicted in FIGS. 14(a) and (b).

The above description is illustrative and not restrictive. Many modifications and variations of the invention will become apparent to those of skill in the art upon review of this disclosure. Embodiments other than those described herein may thus be contemplated and applied without departing from the spirit and scope of the invention as claimed hereafter.

What is claimed is:

1. A composite matrix material for Matrix-assisted Laser Desorption/Ionisation (MALDI), wherein the material comprises
(a) at least one MALDI matrix forming compound, and
(b) a polymer, which serves as supporting material for the at least one MALDI matrix forming compound,
wherein the MALDI matrix forming compound is covalently linked to the polymer.

2. The composite matrix material of claim 1, wherein the MALDI matrix forming compound is covalently linked to the modifiable polymer via an N- or O-containing linker.

3. The composite matrix material of claim 1, wherein the polymer is derived from a modifiable polymer that comprises side chains comprising functional groups selected from the group consisting of photoreactive groups and thermally reactive groups.

4. The composite matrix material of claim 3, wherein said functional groups of said modifiable polymer are selected from the group consisting of epoxy-, nitrilo-, ester-, amido-, carbonyl- and chlorine groups.

5. The composite matrix material of claim 3, wherein the modifiable polymer is selected from the group consisting of polymers of a condensation product of an epoxide and a diol, polymers of methacryamidoacetaldehyde, polyacrylates, poly(vinyl amines), poly(N-propargylamides), polysiloxanes, polysilanes, poly-fluorenes and poly(hydroxyvinylsalicylaldehydes).

6. The composite matrix material of claim 5, wherein the polymer of a condensation product of an epoxide and a diol is selected from the group consisting the polymer of a condensation product of epichlorohydrin and bisphenol-A and the polymer of a condensation product of epichlorohydrin and bisphenol-F.

7. The composite matrix material of claim 5, wherein the polyacrylate is selected from the group consisting of polymethyl methacrylate, poly(n-butyl acrylate) (PBA), and stearyloxypolyethyleneoxy-ethyl-methacrylate (SPMA).

8. The composite matrix material of claim 1, wherein the MALDI matrix forming compound is derived from a compound selected from the group consisting of 4-hydroxycinnamic acid, caffeic acid (3,4-dihydroxy-cinnamic acid), α-cyano-4-hydroxycinnamic acid methyl ester, α-cyano-4-hydroxycinnamic acid, α-cyano-3,4-(methylenedioxy)-cinnamic acid, 2-(4-hydroxyphenylazo) benzoic acid, 4-(acetylamino)-2-hydroxy-5-(phenylazo)-benzoic acid, 2,5-dihydroxy-benzoic acid, 3-hydroxypicolinic acid, nicotinic acid, 2-(bromomethyl)-3-pyridinecarboxylic acid, sinapinic acid, succinic acid, ferulic acid, 2,4,6-trihydroxyacetophenone, 3,4-dihydroxy-α-(ethylamino)acetophenone, 2-mercapto-6-benzothiazole-ethanol, 6-aza-2-thiothymine, 3-(7-hydroxy-1H-indol-3-yl)-2-propenoic acid, dithranol, 1,3,8-trihydroxy-6-methyl-anthrone, isovanillin, 3-(hydroxymethyl)-1-isoquino-linone, trans-3-indoleacrylic acid, t-2-(3-(4-tert-butyl-phenyl)-2-methyl-2-prope-nylidene)malononitrile, 1-methyl-9H-Pyrido[3,4-b]indol-7-ol, 1-ethyl-1,2,3,4-tetrahydro-7-methyl-4-oxo-1,8-naphthyridine-3-carboxylic acid, N1-(5-bromo-2-pyrimidyl)-sulfanilamide, and a derivative thereof.

9. A process for preparing a composite matrix material for Matrix-assisted Laser Desorption/Ionisation (MALDI), comprising reacting:
(a) at least one MALDI matrix forming compound, and
(b) at least one modifiable polymer, generating a polymer, which serves as supporting material for the at least one MALDI matrix forming compound,
wherein said at least one MALDI matrix forming compound is being covalently linked to said modifiable polymer.

10. The process of claim 9, wherein said at least one compound and the at least one modifiable polymer have reactive groups for a covalent linkage with each other.

11. The process of claim 9, wherein the reactive groups of the modifiable polymer are located in side chains of said modifiable polymer.

12. The process of claim 9, wherein said modifiable polymer comprises side chains selected from the group consisting of photoreactive groups and thermally reactive groups.

13. The process of claim 9, wherein said modifiable polymer comprises side chains of the group consisting of epoxy-, nitrilo-, ester-, amido-, carbonyl- and chlorine groups.

14. The process of claim 9, wherein the modifiable polymer is selected from the group consisting of polymers of a condensation product of an epoxide and a diol, polymers of methacryamidoacetaldehyde, polyacrylates, poly(vinyl amines), poly(N-propargylamides), poly(O-propargylesters), polysiloxanes, polysilanes, polyfluorenes, and poly(hydroxyvinylsalicylaldehydes).

15. The process of claim 14, wherein the polymer of a condensation product of an epoxide and a diol is selected from the group consisting of a polymer of a condensation product of epichlorohydrin and bisphenol-A and a polymer of a condensation product of epichlorohydrin and bisphenol-F.

16. The process of claim 14, wherein the polyacrylate is selected from the group consisting of polymethyl methacrylate, poly(n-butyl acrylate) (PBA), and stearyloxypolyethyleneoxy-ethyl-methacrylate (SPMA).

17. The process of claim 9, wherein the at least one MALDI matrix forming compound is selected from the group consisting of 4-hydroxycinnamic acid, caffeic acid (3,4-dihydroxy-cinnamic acid), α-cyano-4-hydroxycinnamic acid methyl ester, α-cyano-4-hydroxycinnamic acid, α-cyano-3,4-(methylenedioxy)-cinnamic acid, 2-cyano-3-(3,4,5-trihydroxyphenyl)-2-propenoic acid, 2-(4-hydroxyphenylazo) benzoic acid, 4-(acetylamino)-2-hydroxy-5-(phenylazo)-benzoic acid, 2,5-dihydroxy-benzoic acid, 3-hydroxypicolinic acid, nicotinic acid, sinapinic acid, succinic acid, ferulic acid, 2,4,6-trihydroxyacetophenone, 3,4-dihydroxy-α-(ethylamino)acetophenone, 2-mercapto-6-benzothiazole-ethanol, 6-aza-2-thiothymine, 2,3,4,5-tetrahydro-5-oxo-3-thioxo-1,2,4-triazine-6-carbonyl chloride, 3-(7-hydroxy-1H-indol-3-yl)-2-propenoic acid, 3-[4-hydroxy-2-(trifluo-romethyl)phenyl]-2-propenoic acid, dithranol, 1,3,8-trihydroxy-6-methyl-anthrone, isovanillin, 3-(hydroxymethyl)-1-isoquinolinone, trans-3-indoleacrylic acid, 7-hydroxy-3-indoleacrylic acid, 3-(6-bromo-1H-indol-3-yl)-2-propenoic acid ethyl ester, t-2-(3-(4-tert-butyl-phenyl)-2-methyl-2-propenylidene)malononitrile, 1-methyl-9H-Pyrido[3,4-b]indol-7-ol, 1-ethyl-1,2,3,4-tetrahydro-7-methyl-4-oxo-1,8-naphthyridine-3-carboxylic acid, N1-(5-bromo-2-pyrimidyl)-sulfanilamide, and a derivative thereof.

18. A method for providing analyte ions for Matrix-assisted Laser Desorption/Ionisation (MALDI) mass spectrometry comprising
(a) providing a composite matrix material comprising at least one MALDI matrix forming compound and a polymer which serves as supporting material for the at least one MALDI matrix forming compound, wherein the MALDI matrix forming compound is covalently linked to the polymer,
(b) contacting said composite matrix material for MALDI with an amount of an analyte, and
(c) irradiating the composite matrix material to desorb and ionize said analyte,
wherein the analyte ions are suitable for analysis of their mass to charge ratio (m/z) in mass spectrometry.

19. The method of claim 18, wherein said MALDI mass spectrometry is selected from the group consisting of time of flight, quadrupole, ion trap, fourier transform mass spectrometry, fourier transform ion cyclotron mass spectrometry and a combination thereof.

20. The method of claim 18, wherein the MALDI matrix forming compound absorbs photon energy at least one wavelength within the range of about 12 μm to about 180 nm.

21. The method of claim 18, wherein the polymer is derived from a modifiable polymer that comprises side chains of the group consisting of epoxy-, nitrilo-, ester-, amido-, carbonyl- and chlorine groups.

22. The method of claim 18, wherein the polymer is derived from a modifiable polymer selected from the group consisting of polymers of a condensation product of an epoxide and a diol, polymers of methacryamidoacetaldehyde, polyacrylates, poly(vinyl amines), poly(N-propargylamides), poly(O-propargylesters), poly-siloxanes, polysilanes, polyfluorenes and poly-(hydroxyvinylsalicylaldehydes).

23. The method of claim 21, wherein the polymer of a condensation product of an epoxide and a diol is selected from the group consisting the polymer of a condensation product of epichlorohydrin and bisphenol-A and the polymer of a condensation product of epichlorohydrin and bisphenol-F.

24. The method of claim 21, wherein the polyacrylate is selected from the group consisting of polymethyl methacrylate, poly(n-butyl acrylate) (PBA), and stearyloxypolyethyleneoxy-ethyl-methacrylate (SPMA).

25. The method of claim 18, wherein the MALDI matrix forming compound is derived from a compound selected from the group consisting of 4-hydroxy-cinnamic acid, caffeic acid (3,4-dihydroxy-cinnamic acid), α-cyano-4-hydroxy-cinnamic acid methyl ester, α-cyano-4-hydroxycinnamic acid, α-cyano-3,4-(methylenedioxy)-cinnamic acid, 2-(4-hydroxyphenylazo)-benzoic acid, 4-(acetylamino)-2-hydroxy-5-(phenylazo)-benzoic acid, 2,5-dihydroxy-benzoic acid, 3-hydroxypicolinic acid, nicotinic acid, sinapinic acid, succinic acid, ferulic acid, 2,4,6-trihydroxyacetophenone, 3,4-dihydroxy-α-(ethylamino)acetophenone, 2-mercapto-6-benzothiazole-ethanol, 6-aza-2-thiothymine, 3-(7-hydroxy-1H-indol-3-yl)-2-propenoic acid, dithranol, 1,3,8-trihydroxy-6-methyl-anthrone, isovanillin, 3-(hydroxymethyl)-1-isoquinolinone, trans-3-indoleacrylic acid, t-2-(3-(4-tert-butyl-phenyl)-2-methyl-2-propenylidene)malononitrile, 1-methyl-9H-Pyrido[3,4-b]indol-7-ol, 1-ethyl-1,2,3,4-tetrahydro-7-methyl-4-oxo-1,8-naphthyridine-3-car-boxylic acid, N1-(5-bromo-2-pyrimidyl)-sulfanilamide, and a derivative thereof.

26. The method of claim 18, wherein the analyte is selected from the group consisting of nucleotides, polynucleotides, nucleic acids, peptides, polypeptides, amino acids, proteins, synthetic polymers, biochemical compositions, organic chemical compositions, inorganic chemical compositions, lipids, carbohydrates, combinatory chemistry products, drug candidate molecules, drug molecules, drug metabolites, cells, microorganisms and any combinations thereof.

27. A substrate for MALDI comprising a solid support, having deposited thereon a composite matrix material for Matrix-assisted Laser Desorption/Ionisation (MALDI), wherein the material comprises
(a) at least one MALDI matrix forming compound, and
(b) a polymer, which serves as supporting material for the at least one MALDI matrix forming compound, wherein the MALDI matrix forming compound is covalently linked to the polymer.

28. A kit for MALDI comprising
(a) one container comprising at least one MALDI matrix forming compound, and
(b) one container comprising at least one modifiable polymer, which is able to generate a polymer that serves as supporting material for the at least one MALDI matrix forming compound,
wherein said at least one MALDI matrix forming compound can be covalently linked to said modifiable polymer.

29. The kit of claim 28, comprising a solid support, whereon the at least one MALDI matrix forming compound and the at least one modifiable polymer may be deposited.
